(19) United States
(12) Patent Application Publication
(10) Pub. No.: US 2013/0255438 A1
(43) Pub. Date: Oct. 3, 2013

(54) Gear housing for a planetary gear, and method for the production of the same

(71) Applicant: IMS GEAR GMBH, Danaueschingen (DE)

(72) Inventor: Matthias Kieninger, Unterkirnach (DE)

(73) Assignee: IMS GEAR GMBH, Danaueschingen (DE)

(21) Appl. No.: 13/758,632

(22) Filed: Feb. 4, 2013

(30) Foreign Application Priority Data
Mar. 27, 2012 (EP) 12 161 553.8

(51) Int. Cl. F16H 57/02

(52) U.S. Cl. CPC F16H 57/02
USPC 74/606 R; 219/121.64

(57) ABSTRACT

The invention relates to a gear housing for a planetary gear, for the purpose of accommodating the toothed components, which form the planetary gear, having a hollow cylindrical housing body comprising an inner toothing, wherein said housing body can be connected on both end faces thereof to a mounting flange, wherein according to the invention, the configuration includes—the housing body and at least one mounting flange are designed to each overlap axially on end faces thereof to form an overlap region,—in the overlap region, the housing body and the at least one mounting flange are designed with a press connection, and—at least in the overlap region, a material that is transparent to laser light, and a material that is not transparent to laser light, are included as the materials for the housing body and for the at least one mounting flange.

### CROSS REFERENCE TO RELATED APPLICATIONS

This patent application claims priority to European Patent Application 12 161 553.8, filed on Mar. 27, 2012.

### STATEMENT REGARDING FEDERALLY SPONSORED RESEARCH OR DEVELOPMENT

No federal government funds were used in researching or developing this invention.

### NAMES OF PARTIES TO A JOINT RESEARCH AGREEMENT

Not applicable.

### SEQUENCE LISTING INCLUDED AND INCORPORATED BY REFERENCE HEREIN

Not applicable.

### BACKGROUND

1. Field of the Invention

The invention relates to a gear housing for a planetary gear, as well as to a method for the production of the gear housing according to the invention, and to a planetary gear having the gear housing according to the invention.

The function of planetary gears is known. A sun gear is disposed in the center and is driven by a motor. The motor is connected to the planetary gear via a motor flange and/or input flange. The sun gear transmits its movement to at least two or three circumferential planet gears which form a gear speed and which are arranged on mounting bolts of a planet gear carrier. In configurations with multiple gear speeds, the last planet gear carrier is fixed to a drive shaft mounted in an output flange, and thereby provides the transmission of force to the output shaft. The planet gears run on the outside thereof in a gear housing having an inner toothing, the so-called ring gear.

### BACKGROUND OF THE INVENTION

The current state of knowledge is as follows.

The object of the invention is a planetary gear housing with increased efficiencies, both in utility and cost, compared to such gears commercially available today.

A planetary gear, which represents the type known from DE 20 2007 003 419 U1, wherein the sun gear, the planet gear carrier, and the ring gear consist of plastic. The ring gear is covered on one end-face thereof by a motor flange designed as a covering cylinder, while on the output side, the ring gear is disposed on an output flange designed as a socket.

The connection between the ring gear and the output flange and/or input flange is conventionally realized in planetary gears by means of a bolted connection, particularly when the components of such a connection are made of metal.

DE 2 261 388 A describes a laser welding method for welding a plastic end piece to a tube-shaped plastic body, wherein the end face of the plastic end piece is inserted into the plastic body, forming a press fit, such that a ring-shaped contact zone is formed as a result between the end piece and the tube-shaped body, and a laser beam is directed to this contact zone in order to weld the two parts to each other. At the same time as the laser beam is applied, a relative rotary movement between the laser beam and the tube-shaped plastic body, together with the end piece, is executed, such that a peripheral weld seam is created as a result.

This laser beam welding approach has become an alternative to other joining techniques known from the prior art, such as bolting or bonding. In the laser beam welding process, laser light passes through a component, which is transparent to laser light, and is absorbed on the surface of a second component, such that the surface thereof melts locally. Because of the surface contact between the two components, the same being pressed against each other during the welding process, the workpiece, which is transparent to the laser light is also melted locally, such that a laser weld seam is formed in the region of a boundary surface between the two workpieces after cooling.

As such, point 7.2.1 of the DVS Guideline 2242 notes that, for connections formed by means of laser transmission welding in processes with no pathway for the removal of melt, the surfaces being joined must abut evenly and be nearly completely free of any gap. According to this guideline, this can be achieved by pressing, using hold-down clamps or snap joiners. In addition, the guideline notes that in practice, it has proven useful to employ press fittings for applications involving circular joint cross-sections.

The problem addressed by the invention is that of providing a gear housing for a planetary gear of the above type, which can be built as a fully-plastic planetary gear with corresponding toothed components, meaning at least one planet gear carrier with planet gears, and at least one sub gear. A further problem addressed by the invention is that of providing a method for the production of such a gear housing.

### BRIEF SUMMARY OF THE INVENTION

In a preferred embodiment, a gear housing for a planetary gear comprising a hollow cylindrical housing body comprising an inner toothing, wherein said housing body can be connected on both end faces thereof to a mounting flange, further comprising wherein (i) the housing body and at least one mounting flange are designed to each overlap axially on end faces thereof to form an overlap region, (ii) in the overlap region, the housing body and the at least one mounting flange are designed with a press connection, and (iii) at least in the overlap region, each of a material which is transparent to laser light and a material which is not transparent to laser light are included as the materials for the housing body and for the at least one mounting flange, such that the housing body and the at least one mounting flange are welded to each other in the overlap region by means of laser transmission welding by a laser beam directed into the interior of the gear housing.

The gear housing as disclosed, wherein the housing body is designed with an axial flange, which coaxially encloses an edge region of the mounting flange on an end face of the housing body for the purpose of forming the overlap region.

The gear housing as disclosed, wherein the overlap region of at least one mounting flange is designed as a shaft, which is concentrically enclosed by the axial flange of the housing body.

The gear housing as disclosed, wherein the shaft is bounded by a radial shoulder surface and the end face of the axial flange of the housing body abuts said shoulder surface.

The gear housing as disclosed, wherein at least one circumferential weld seam is included for the purpose of welding the housing body to the at least one mounting flange in the region of the press fit.

The gear housing as disclosed, further comprising wherein at least one further circumferential welded seam is included at an axial distance from a circumferential welded seam in the region of the press fit.

The gear housing as disclosed, wherein thermoplastic materials are used as the materials that are transparent and non-transparent to laser light.

The gear housing as disclosed, wherein a laser-transparent material is used that is transparent to a wavelength or a wavelength range, and a laser-impermeable material is used that is impermeable to a wavelength or wavelength range.

The gear housing as disclosed, wherein the mounting flanges are designed as mounting flanges on the output side and the input side.

A method for the production of the gear housing as disclosed, wherein the laser transmission welding of the housing body to at least one mounting flange is accomplished by directing a laser beam toward an outer surface of the housing body in the overlap region and completely around the periphery of the gear housing.

A method as disclosed, wherein the gear housing executes at least one full rotation to guide the laser radiation peripherally around the same.

A planetary gear comprising a gear housing as disclosed, further comprising at least one planet gear carrier with at least one planet gear running peripherally in the inner toothing of the housing body, wherein the planet gear carrier is functionally connected on the output side to an output shaft mounted in an output-side mounting flange, and further comprising a sun gear which engages with the at least one planet gear, said sun gear being functionally connected to an input shaft mounted in the input-side mounting flange.

A planetary gear as disclosed, wherein the planet gears, together with at least one planet gear carrier and at least one sun gear are produced of plastic.

### BRIEF DESCRIPTION OF THE DRAWINGS

FIG. 1 is a line drawing evidencing a perspective cutaway view of a gear housing having an inner toothing, and having mounting flanges on the input and output sides, for a planetary gear, as one embodiment of the invention.

FIG. 2 is a line drawing evidencing a cutaway view of the gear housing according to FIG. 1, having toothed components.

FIG. 3 is a line drawing evidencing an enlarged illustration of a detail X from FIGS. 1 and 2.

FIG. 4 is a line drawing evidencing an illustration of detail X in FIG. 3, with weld seams.

### DETAILED DESCRIPTION OF THE INVENTION

The invention comprises a gear housing for a planetary gear, said gear housing functioning to accommodate the toothed components which form the planetary gear, having a hollow cylindrical housing body with an inner toothing, said cylindrical housing body being able to connect on both end faces thereof to a mounting flange, is characterized according to the invention in that the housing body and at least one mounting flange are constructed to each overlap axially on end faces thereof to form an overlap region, in that the housing body and the at least one mounting flange are designed having a press connection, and particularly a press-fit connection, in the overlap region, and in that at least in the overlap region, a material which is transparent to light and a material which is impermeable to light are included as materials for the housing body and for the at least one mounting flange, in such a manner that the housing body and the at least one mounting flange are welded to each other in the overlap region by means of laser transmission welding by a laser beam directed into the interior of the gear housing in the overlap region.

By means of the gear housing according to the invention, a compact construction with minimum weight is achieved for the gear housing, wherein the number of components is reduced by, for example, the absence of bolted connections. In addition, the complexity of assembly is reduced compared to, for example, a configuration including a bolted connection.

In one advantageous embodiment of the invention, the housing body is designed with an axial flange on one end face thereof, said axial flange coaxially enclosing an edge region of the at least one mounting flange, for the purpose of forming the overlap region. The assembly is simplified in this manner, because the at least one mounting flange only needs to be inserted by the end face thereof on the housing body. In addition, this axial flange can be designed with a wall thickness, which only absorbs a minimal fraction of the incoming laser beam.

The overlap region of the at least one mounting flange is preferably designed as a shaft, which is concentrically enclosed by the axial flange of the housing body. The shaft is preferably bounded by a radial shoulder surface, wherein the end face of the axial flange of the housing body abuts said shoulder surface. In this way, the position of the mounting flange is defined, preventing a faulty assembly.

In one particularly advantageous implementation of the invention, at least one circumferential weld seam is included for the purpose of welding the housing body to the at least one mounting flange in the region of the press fit. In this way, the configuration ensures that the gear housing is tightly closed. In order to ensure a tight seal of the gear housing over the operating life of the planetary gear, according to one implementation at least one further circumferential weld seam is included at an axial distance from a circumferential weld seam in the region of the press fit.

In a further embodiment of the invention, thermoplastic materials are used as the materials which are transparent to and impermeable to laser light. In this case, a laser-transparent material is preferably used, which is transparent to a wavelength or a wavelength range, while for the laser-impermeable material, a material, which is impermeable to a wavelength or wavelength range is used.

The second problem addressed by the invention is addressed by a method for the production of a gear housing for a planetary gear, according to the invention, having the features of claim 11.

Such a method is characterized according to the invention in that, for the laser transmission welding of the housing body to the at least one mounting flange, a laser beam is directed on an outer surface of the housing body in the overlap region, completely around the periphery of the gear housing.

In this case, it is particularly advantageous if the relative rotation between the laser beam and the gear housing is realized by executing at least one complete rotation with the gear housing, meaning the laser remains fixed during the process.

A planetary gear constructed using the gear housing according to the invention has at least one planet gear carrier with at least one planet gear, the same running in the inner toothing of the housing body, wherein the planet gear carrier is functionally connected on the output side thereof to an output shaft mounted in a mounting flange on the output side, and also has a sun gear, which engages with the at least one planet gear, wherein said sun gear is functionally connected to an input shaft mounted in the mounting flange on the input side.

A fully-plastic planetary gear is created by means of the gear housing according to the invention in that the housing body with the inner toothing and the mounting flanges, as well as the planet gears, together with the planet gear carrier and the sun gear, are produced from plastic. In addition to a noise reduction during operation of the planetary gear, this also leads to a reduction in weight, which is particularly advantageous in automotive applications.

### DETAILED DESCRIPTION OF THE FIGURES

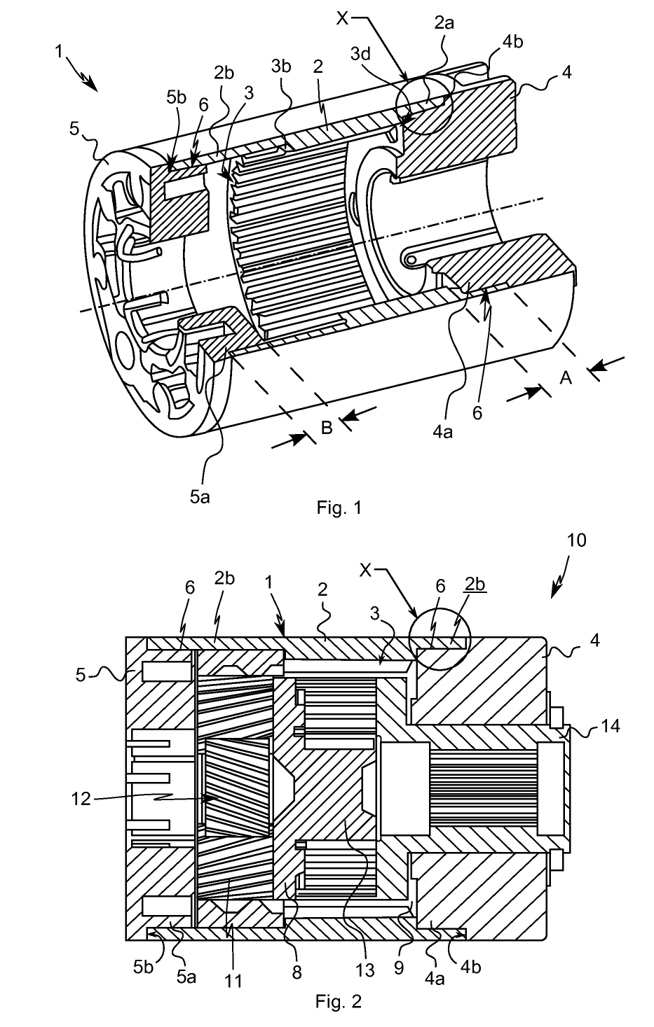

According to FIG. 1, the gear housing 1 according to the invention consists of a planetary gear made of a tubular or hollow cylindrical housing body 2, which consists, in a central region thereof, of an inner toothing 3 designed as a toothed ring, and of mounting flanges 4 and 5, which are each attached on the housing body 2 by the end faces thereof, and which are designed as an output mounting flange 4 and as an input mounting flange 5.

FIG. 2 shows a planetary gear 10 constructed with this gear housing 1 as in FIG. 1, wherein this gear housing accommodates corresponding toothed components such as a planet gear carrier with planet gears and sun gears, as well as input and output shafts.

The gear housing 1, and particularly the method of connecting the two mounting flanges 4 and 5 to the housing body 2 by means of laser transmission welding, will first be described with reference to FIGS. 1, 3, and 4.

The two end faces of the housing body 2 are each designed with an axial flange 2a and 2b, each of which are bounded by an end-face shoulder surface 3a and 3b of the toothed ring 3. In order to make it possible to attach the two mounting flanges 4 and 5 via the end faces thereof to the housing body 2, both of the mounting flanges 4 and 5 have a shaft 4a and 5a with an outer diameter, which is adapted to the inner diameter of the ring-shaped axial flanges 2a and 2b. The peripheral surface of the shaft 4a and/or 5b of the mounting flange 4 and/or 5 ends in a shoulder surface 4b and/or 5b, such that the end face of the axial flange 2a and/or 2b abuts this shoulder surface 4b and/or 5b upon the attachment of the mounting flange 4 and/or 5, thereby creating an axial overlap region A and/or B between, on the one side, the housing body 2 with the mounting flange 4, and on the other side, the mounting flange 5. In this case, the axial flange 2a and/or 2b surrounds the shaft 4a and/or 5a of the mounting flanges 4 and/or 5 concentrically.

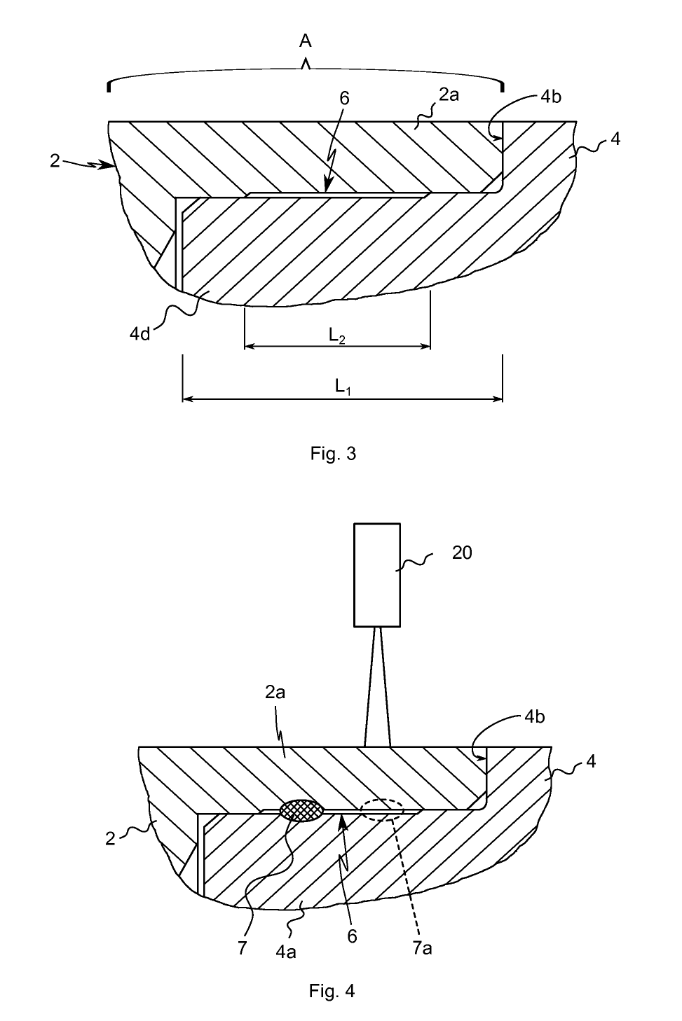

In FIG. 3, the enlarged illustration of the detail X from FIG. 1 shows a shaft 4a of the mounting flange 4, having an axial length of 11, which substantially corresponds to the axial length of the overlap region A between the housing body 2 and the mounting flange 4, which in this case is the output-side mounting flange.

In this overlap region A shown in FIG. 3, the housing body 2 and the mounting flange 4 are designed with a press fit 6 for the length 12, which runs substantially centrally with respect to the length 11 of the overlap region A. This means that in this region 6, the outer diameter of the shaft 4a is larger than the inner diameter in the region of the axial flange 2a, including the respective tolerance ranges of these two sizes.

According to FIG. 3, the axial flange 2b of the housing body 2 and the input-side mounting flange 5 are designed with a press fit 6. Here as well, the press fit is included in the central region of the overlap region B formed by the shaft 5a of the mounting flange 5 and the axial flange 2b of the housing body 2, meaning that the outer diameter of the shaft 5a in this region is larger than the inner diameter of the axial flange 2b, including the respective tolerance ranges of these two sizes.

When the mounting flange 4 is inserted into and/or pressed into the housing body 2, the contact surfaces in the region of the press fit 6 are pressed against each other such that substantially no gap exists.

Next, a circumferential weld seam can be produced, according to the principle of transmission welding, between the inner wall of the axial flange 2a and/or 2b and the outer wall of the shaft 4a and/or 5a of the mounting flange 4 and/or 5, by means of a laser 20, the laser radiation of which is directed at the press fit region 6 from radial positions outside of the same, as shown in FIG. 4 for the mounting flange 4 on the output side.

To make it possible to carry out the laser transmission welding process, the housing body 2 consists of a plastic which is transparent to the laser radiation of the laser 20 used, meaning that the material of such a plastic has a low absorption constant. The two mounting flanges 4 and 5 are produced from a plastic, which is opaque or only slightly transparent to the laser radiation used, meaning that this material has a high absorption constant.

For this reason, the laser radiation of the laser 20 initially penetrates the axial flange 2a and/or 2b substantially without hindrance, and then strikes the shaft 4a and/or 5a of the mounting flange 4 and 5, where it is absorbed and converted into heat. When increased energy is applied by the laser radiation, the material of the shaft 4a and/or 5a melts in the region of the press fit, and more precisely in the region of the energy absorption volume, and this leads to a melting of the axial flange 2a and/or 2b in this region, such that a permanent material connection is formed by the mixing of the melts and the setting of the melts after cooling, as is illustrated in FIG. 4 as a weld seam 7.

This circumferential weld seam 7 in FIG. 4 is formed by the gear housing 1 and/or the assembled planetary gear 10 undergoing an axial rotation, such that the laser radiation of the laser 20 is directed onto the outer surface of the housing body 1 upon at least one full rotation thereof. A further, axially displaced, welded seam 7a can be produced in the same manner (cf. FIG. 4). It is also possible to produce the two weld seams 7 and 7a at the same time by means of a beam splitter, which splits the beam of the laser 20 into two beams, wherein the gear housing 1 and/or the assembled planetary gear 10 are also rotated axially for a full rotation in this case.

In producing the welded seam 7 and/or the two welded seams 7 and 7a, more than just one full rotation may be necessary.

At some point before both of the mounting flanges 4 and 5 are connected to the housing body 2 by a material connection, the toothed components required for the planetary gear must be mounted in the gear housing 1.

FIG. 2 shows an assembled planetary gear 10 having the gear housing 1 according to the invention. This planetary gear 10 is constructed as a two-speed gear with a first planet gear carrier 8, which carries planet gears (not illustrated), and a second planet gear carrier 9, which also carries planet gears (not illustrated). The planet gears of the first planet gear carrier engage with a further ring 11, while the planet gears of the second planet gear carrier 9 engage with the inner toothing 3 of the housing body 2.

A sun gear 12, which is arranged on a drive shaft (not illustrated) mounted on a mounting flange 5 on the input side drives the planet gears of the first planet gear carrier 8. A sun gear 13 connected on the output side to the first planet gear carrier 8 engages with the planet gears of the second planet gear carrier 9, which forms an output shaft 14 on the output side.

The planetary gear 10 according to FIG. 2 can be designed as a fully-plastic gear, wherein not only the gear housing 1 but also the associated toothed components consist of plastic, such as the planet gear carriers 8 and 9 with the associated planet gears, as well as the sun gears 12 and 13.

### LIST OF REFERENCE NUMBERS

1 gear housing
2 housing body of gear housing 1
2a axial flange of the housing body 2
2b axial flange of the housing body 2
3 inner toothing,
3a shoulder surface of the inner toothing 3
3b shoulder surface of the inner toothing 3
4 mounting flange, output flange
4a shaft of the mounting flange 4
4b shoulder surface of the shaft 4a
5 mounting flange, input flange
5a shaft of the mounting flange 5
5b shoulder surface of the shaft 4a
6 press fit
7 weld seam
7a weld seam
8 planet gear carrier
9 planet gear carrier
10 planetary gear
11 ring
12 sun gear
13 sun gear (second)
14 drive shaft
A overlap region
B overlap region
l₁ length of the overlap region A, B
l₂ length of the press fit

The references recited herein are incorporated herein in their entirety, particularly as they relate to teaching the level of ordinary skill in this art and for any disclosure necessary for the commoner understanding of the subject matter of the claimed invention. It will be clear to a person of ordinary skill in the art that the above embodiments may be altered or that insubstantial changes may be made without departing from the scope of the invention. Accordingly, the scope of the invention is determined by the scope of the following claims and their equitable Equivalents.

We claim:

1. A gear housing for a planetary gear comprising a hollow cylindrical housing body comprising an inner toothing, wherein said housing body can be connected on both end faces thereof to a mounting flange, further comprising wherein (i) the housing body and at least one mounting flange are designed to each overlap axially on end faces thereof to form an overlap region, (ii) in the overlap region, the housing body and the at least one mounting flange are designed with a press connection, and (iii) at least in the overlap region, each of a material which is transparent to laser light and a material which is not transparent to laser light are included as the materials for the housing body and for the at least one mounting flange, such that the housing body and the at least one mounting flange are welded to each other in the overlap region by means of laser transmission welding by a laser beam directed into the interior of the gear housing.

2. The gear housing of claim 1, wherein the housing body is designed with an axial flange, which coaxially encloses an edge region of the mounting flange on an end face of the housing body for the purpose of forming the overlap region.

3. The gear housing of claim 2, wherein the overlap region of at least one mounting flange is designed as a shaft, which is concentrically enclosed by the axial flange of the housing body.

4. The gear housing of claim 3, wherein the shaft is bounded by a radial shoulder surface and the end face of the axial flange of the housing body abuts said shoulder surface.

5. The gear housing of claim 1, wherein at least one circumferential weld seam is included for the purpose of welding the housing body to the at least one mounting flange in the region of the press fit.

6. The gear housing of claim 5, further comprising wherein at least one further circumferential welded seam is included at an axial distance from a circumferential welded seam in the region of the press fit.

7. The gear housing of claim 1, wherein thermoplastic materials are used as the materials that are transparent and non-transparent to laser light.

8. The gear housing of claim 1, wherein a laser-transparent material is used that is transparent to a wavelength or a wavelength range, and a laser-impermeable material is used that is impermeable to a wavelength or wavelength range.

9. The gear housing of claim 1, wherein the mounting flanges are designed as mounting flanges on the output side and the input side.

10. A method for the production of the gear housing of claim 1, wherein the laser transmission welding of the housing body to at least one mounting flange is accomplished by directing a laser beam toward an outer surface of the housing body in the overlap region and completely around the periphery of the gear housing.

11. The method of claim 10, wherein the gear housing executes at least one full rotation to guide the laser radiation peripherally around the same.

12. A planetary gear comprising the gear housing of claim 1, further comprising at least one planet gear carrier with at least one planet gear running peripherally in the inner toothing of the housing body, wherein the planet gear carrier is functionally connected on the output side to an output shaft mounted in an output-side mounting flange, and further comprising a sun gear which engages with the at least one planet gear, said sun gear being functionally connected to an input shaft mounted in the input-side mounting flange.

13. The planetary gear of claim 12, wherein the planet gears, together with at least one planet gear carrier and at least one sun gear are produced of plastic.
